(19) United States
(12) Patent Application Publication
(10) Pub. No.: US 2014/0376218 A1
(43) Pub. Date: Dec. 25, 2014

(54) LED Strip Assembly for Generating an Extra Wide Beam of Light

(71) Applicant: Yaxi Ni, Rancho Cucamonga, CA (US)

(72) Inventor: Yaxi Ni, Rancho Cucamonga, CA (US)

(73) Assignee: ATG ELECTRONICS, INC., Rancho Cucamonga, CA (US)

(21) Appl. No.: 14/082,202

(22) Filed: Nov. 18, 2013

Related U.S. Application Data
(60) Provisional application No. 61/837,171, filed on Jun. 20, 2013.

(51) Int. Cl. F21S 4/00

(52) U.S. Cl. CPC F21S 4/003
USPC 362/217.14

(57) ABSTRACT

The invention discloses an LED strip assembly for generating an extra wide beam light of greater than 180 degrees, comprising one linear support structure (typically of aluminum material), and at least two LED arrays. In addition, the support structure has an upper part, a lower part and two grooves in between. The said LED arrays are arranged on the upper part; the lower part is arc shaped and of 1 PI radians or less, having fins to dissipate heat to ambient environment.

### CROSS-REFERENCE TO RELATED APPLICATIONS

Provisional application No. 61/837,171, filed on Jun. 20, 2013

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF THE INVENTION

The present invention relates to an LED strip assembly for generating an extra wide beam light.

In particular, the LED strip assembly has one linear support structure and at least two LED arrays and emits light of greater than 180 degrees.

### BACKGROUND OF THE INVENTION

Lighting system based on LED light sources is a fairly new technology in the lighting field. The LED technology has obvious advantages of low maintenance, low power consumption and long life span compared to conventional lighting technologies.

However, different from conventional lighting technologies, such as linear fluorescent tubes, which emit omnidirectional light, LED lighting system emits directional light, typical less than 150 degree. For applications such as offices, manufacturing areas, warehouses, etc., the lighted area shall be as large and even as possible.

To attempt to achieve similar lighting effects as conventional lighting, as a solution, more LED lighting products are installed to produce more light and cover larger area. This approach just leads to higher cost to the end user.

To overcome the said issue, the inventor proposes a solution as described below.

### SUMMARY OF THE INVENTION

The main objective of the invention is to provide an LED strip assembly which emits an extra wide beam of light, and more particularly the beam of light is more than 180 degrees. The LED strip assembly shall be simple in structure, easy for maintenance and mass-producible.

In accordance with the present invention, there is provided an LED strip assembly comprising a linear support structure and at least two LED arrays.

In further aspects of the invention, the linear support structure has an upper part, a lower part and a groove in between. At least two LED arrays are arranged on the upper part and extend along the support structure. The lower part has fins to dissipate heat generated by LED arrays to ambient environment. In one embodiment, a diffuser might be secured in the groove.

These and other aspects of the invention are described in the detailed description of the invention and claimed in the claims that follow.

### BRIEF DESCRIPTION OF THE DRAWINGS

The present invention will be further understood from the following description with reference to the accompanying drawings, in which:

FIG. 1 is a section view of an LED strip assembly;

FIG. 2 is a 3D view of the LED strip assembly;

FIG. 3 is a top view of the LED strip assembly;

FIG. 4 shows some examples of the upper part for the LED strip assembly;

FIG. 5 shows the beam of light distribution of the LED strip assembly; and

FIGS. 6-7 show an embodiment of the LED strip assembly with lens installed.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “present invention” merely for convenience and without intending to voluntarily limit the scope of this application to any particular invention or inventive concept.

Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The below disclosed subject matter is to be considered illustrative, and not restrictive, and the appended claims are intended to cover all such modifications, enhancements, and other embodiments which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The terminology used herein is for the purpose of describing particular embodiments only and is not intended to be limiting of the present inventive subject matter. As used herein, the singular forms “a”, “an” and “the” are intended to include the plural forms as well, unless the context clearly indicates otherwise.

It will be understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be further understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

In the drawings, the thickness of layers and regions are exaggerated for clarity. It will also be understood that when an element such as a layer, region or substrate is referred to as being “on” or “onto” another element, it may lie directly on the other element or intervening elements or layers may also be present. Like reference numerals refer to like elements throughout the specification.

Spatially relatively terms, such as “beneath,” “below,” “above,” “upper,” “top,” “bottom” and the like, may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, when the device in the figures is turned over, elements described as below and/or beneath other elements or features would then be oriented (rotated 90 degrees or at other orientations) and the spatially relative descriptors used herein interpreted accordingly. As used herein, “height” refers to a direction that is generally orthogonal to the faces of a substrate.

The present invention relates to LED strip assembly 10 and methods for generating an extra wide beam light of greater than 180 degrees, comprising a plurality of LEDs 106, at least two circuit boards 105 and one linear support structure 100.

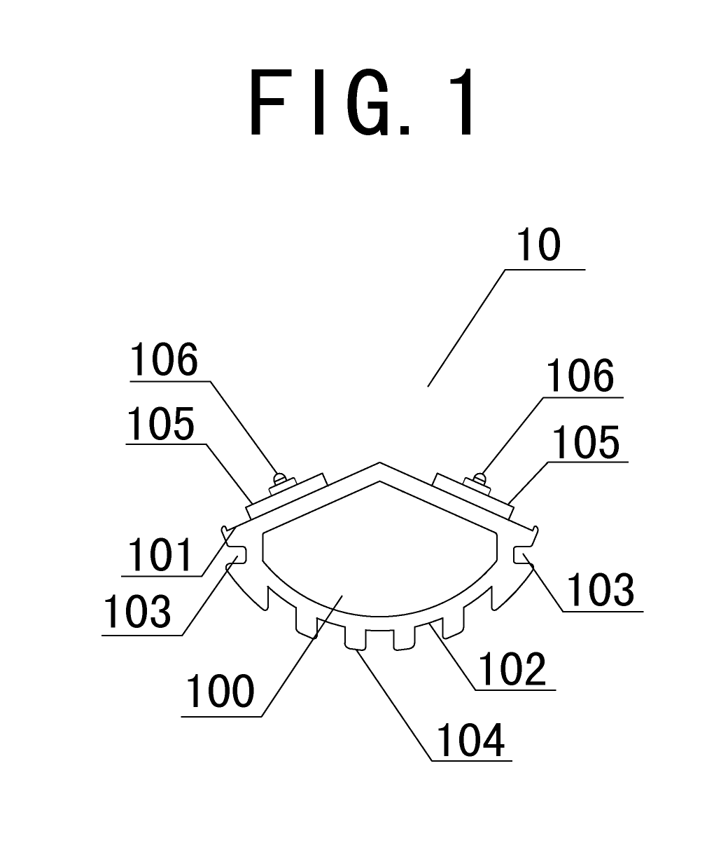

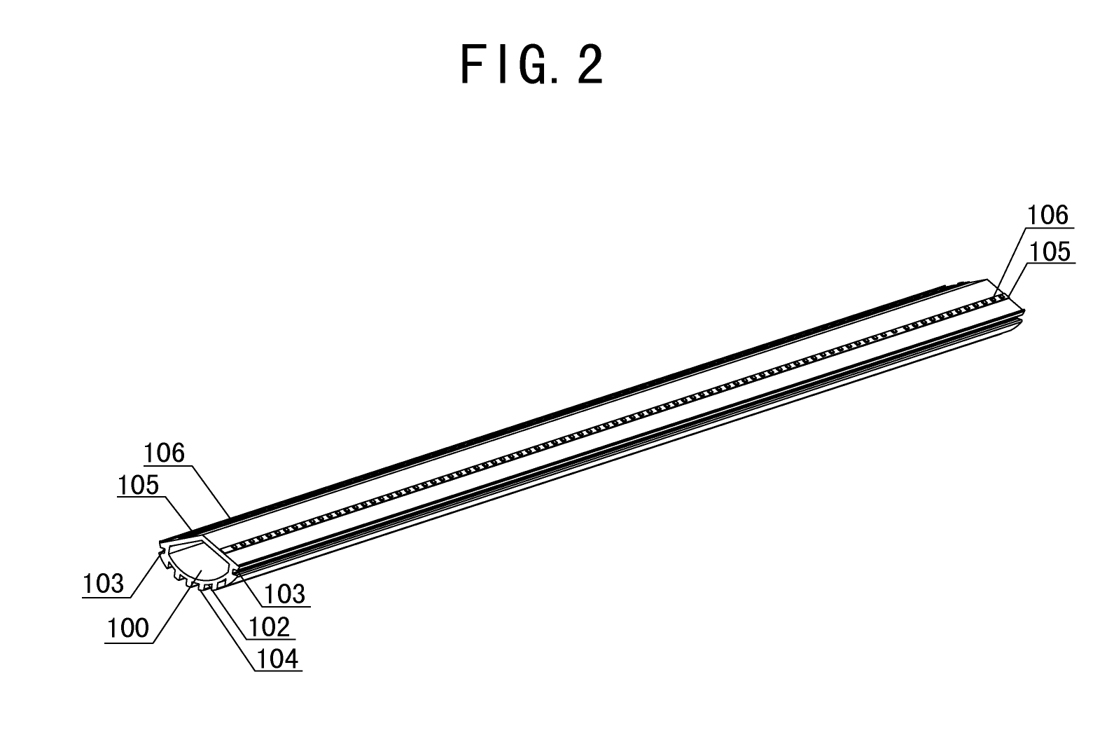

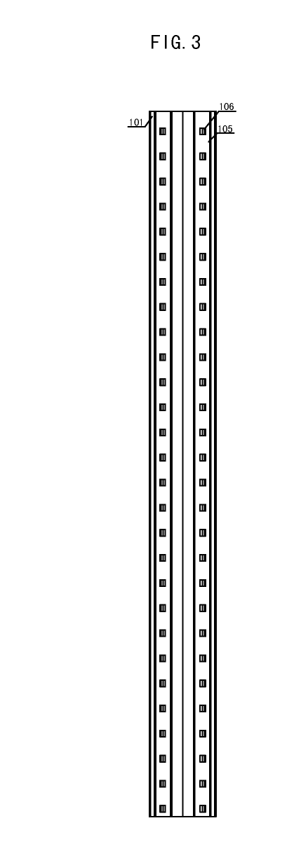

FIGS. 1-3 show an exemplary LED strip assembly 10 includes a plurality of LEDs 106, at least two circuit boards 105 and one linear support structure 100. LED 106, having a power rating from 0.1 watts to 0.5 watts, may be SMD type, through-hole type, lamp type or any other type now known or later developed. The beam angle of light emitted by LED 106 is less than 150 degrees. Each LED 106 is arranged on the circuit board 105 which may be fiber glass based type, metal core (for example aluminum) based type, ceramics based type or any other type now known or later developed and may be rigid or flexible in shape. The support structure 100 forms a long hollow housing, extends from end to end of the LED strip assembly 10, and is typically made of a unitary piece of aluminum or any other heat conductive and rigid material. The support structure 100 further comprises an upper part 101, a lower part 102 and two grooves 103 in between. Circuit boards 105 are arranged on upper part 101 of LED strip assembly 10. Lower part 102 is arc shaped and of 1 PI radians or less, having fins 104 to dissipate heat to ambient environment. Grooves 103 are between upper part 101 and lower part 102, facing outside of the LED strip assembly 10.

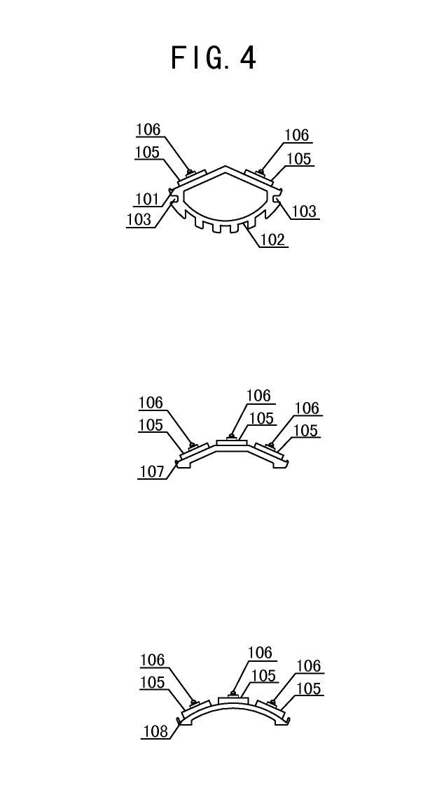

FIG. 4 shows various shapes of upper part 101 including V-shaped 101, bottom-up channel shaped 107, and arc shaped 108. The V-shaped upper part 101 is arranged with two circuit boards 105 on each side. The bottom-up channel shaped upper part 107 is arranged with three circuit boards 105 on each side. The arc shaped upper part 108 is arranged with three circuit boards 105.

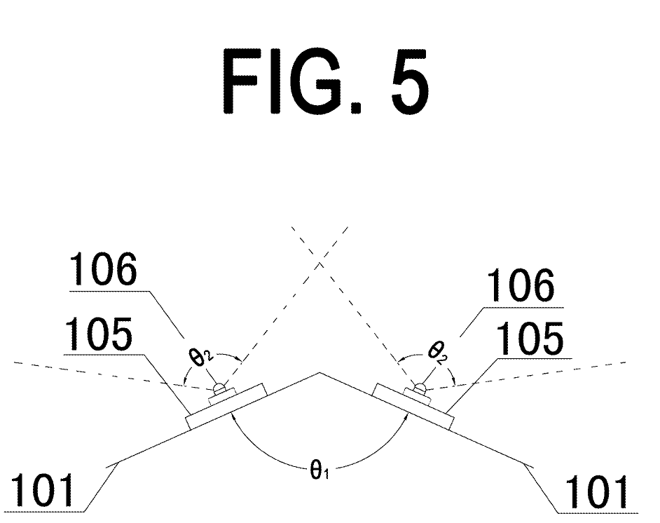

FIG. 5 shows the beam of light distribution of the LED strip assembly 10. The inner angle θ₁ of upper part 101 is 30 degrees or greater. The beam angle θ₂ of light emitted by LED 106 is 150 degrees or less. By setting the inner angle θ₁ to be 30 degrees or greater, LEDs 106 arranged on circuit boards 105 emit light which is mixed and directed to the ambient environment. Thus beam angle of light output by LED strip assembly 10 would exceed 180 degrees.

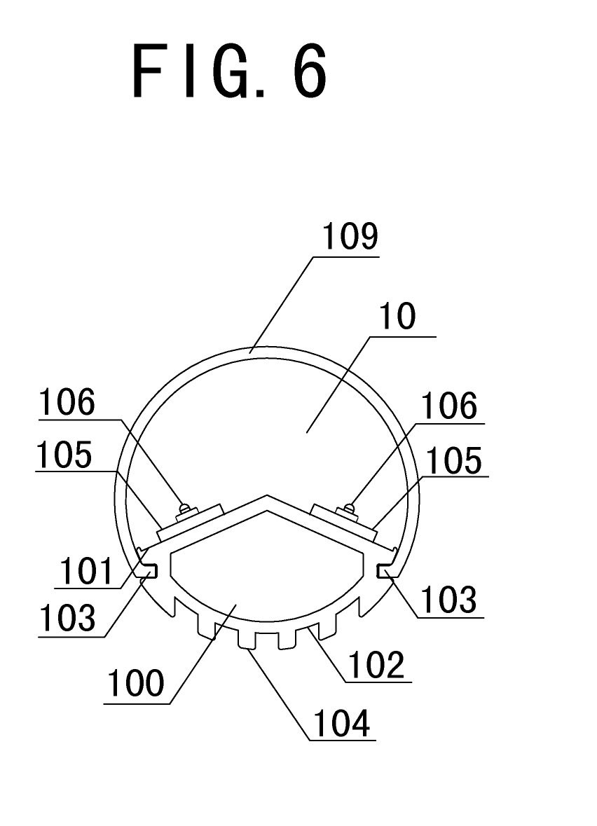

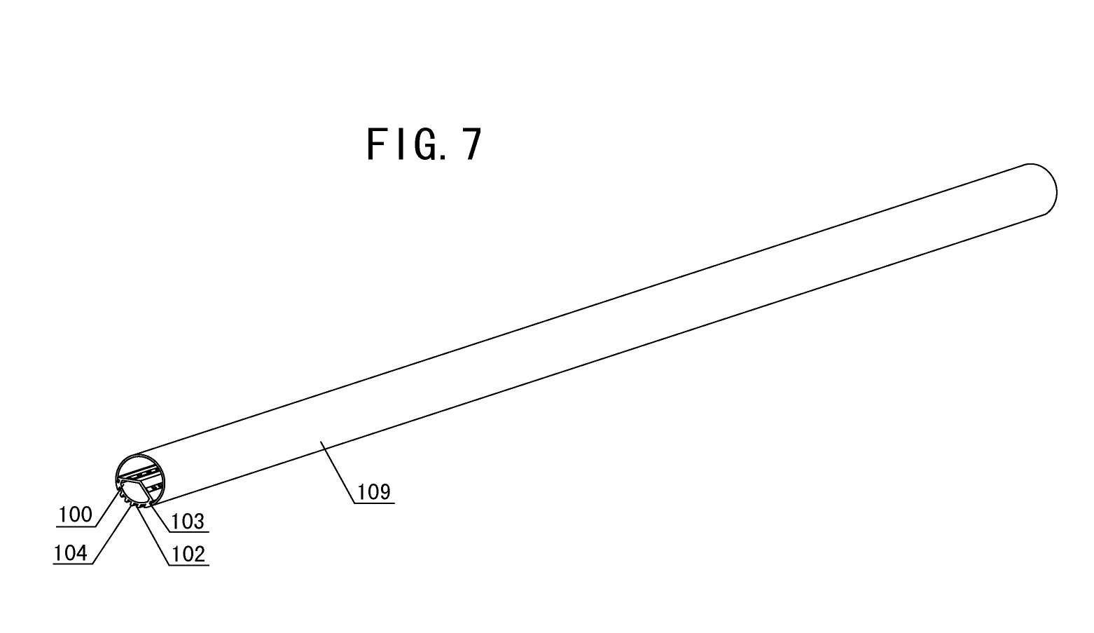

FIGS. 6-7 show an embodiment, the support structure 100 may be provided with a luminous diffuser 109 secured in grooves 103 that run along the outside edge of linear support structure 100. The diffuser 109 may, for example, be provided as an acrylic, polycarbonate, PET, PETG, PMMA, ABS or other lighting trans-missive material and may be provided in frosted type (a milky looking to distribute light smoothly), clear type (a transparent looking to maximally distribute light out to the environment), or striated type (a diffusing structure to distribute light to reduce glare).

What is claimed is:

1. An LED strip assembly comprising:
a linear support structure forming an upper part spanning between a first end and a second end;
the linear support structure forming a lower part below the upper part spanning between a first end and a second end;
the linear support structure forming two grooves between the upper part and the lower part;
at least two circuit boards arranged on the upper part; and
a plurality of LEDs arranged on the circuit boards.

2. The LED strip assembly of claim 1 generates light of beam angle greater than 180 degrees.

3. The LED strip assembly of claim 1 in which the linear support structure is a long hollow housing made of a unitary piece of heat conductive and rigid material.

4. The LED strip assembly of claim 1 in which the upper part forms a shape having an inner angle of 30 degrees or greater.

5. The LED strip assembly of claim 1 in which the lower part is arc shaped and of 1 PI radians or less, having fins.

6. The LED strip assembly of clam 1 in which the grooves are facing outside of the assembly.

7. The LED strip assembly of claim 1 in which each LED has a power rating between 0.1 watts and 0.5 watts and has a beam angle less than 150 degrees.
